(19) United States
(12) Patent Application Publication
(10) Pub. No.: US 2021/0025555 A1
(43) Pub. Date: Jan. 28, 2021

(54) LED STRIP WITH DISCONTINUOUS ILLUMINATION

(71) Applicant: OHMIO SERVICIOS INTEGRALES, S.L., Madrid (ES)

(72) Inventor: Andrés Pereira González, Madrid (ES)

(21) Appl. No.: 17/045,682

(22) PCT Filed: Nov. 15, 2018
(86) PCT No.: PCT/ES2018/070738

§ 371 Date: Oct. 6, 2020

(30) Foreign Application Priority Data
Apr. 6, 2018 (ES) U201830475

(51) Int. Cl. F21S 4/24; F21V 21/08

(52) U.S. Cl. CPC F21S 4/24; F21Y 2115/10; F21V 21/08

(57) ABSTRACT

The invention relates to a LED strip with discontinuous illumination which does not break when bent, folded, or bowed, thereby providing correct illumination, even when bent, folded, or bowed. Said LED strip comprises at least a first section, in turn comprising a laminar support on one or both faces of which LEDs are attached, and a second section comprising at least one conductor connected to the first section, such that said strip can be bent, bowed, or folded by the second section in the same plane as that of the laminar support.

### TECHNICAL FIELD OF THE INVENTION

The present invention is comprised in the field of LED strips making up linear illumination systems with LEDs.

### BACKGROUND OF THE INVENTION

As a result of their manufacturing method, LED strips are produced continuously to configure strips having a length of several meters which can later be cut as needed. They are mainly made up of a laminar support, by way of a printed circuit board (PCB) with its connections, on which LEDs are arranged. Since said laminar support is a strip, it allows the bending, bowing, or folding thereof in planes transverse or parallel to that of the strip, however it does not allow such operations in the same plane of the laminar support, by way of twisting in the same plane, since the connections and welds of the LEDs may break, so the electrical connection is interrupted, and therefore the LED strip does not light up.

Another drawback of the known LED strips is that if several LEDs are folded, they may overlap one another, causing the strips to overheat; and another drawback is that illumination in the bent, bowed, or folded area would be compromised, with said illumination being sent in the wrong direction.

This problem is highly relevant today because architectural requirements demand bends and turns that follow the walls, ceiling, floor, and any other construction element situated in the building to be illuminated, which implies assured continuous electrical transmission despite the bend and turn.

### DESCRIPTION OF THE INVENTION

The present invention is set forth and characterized in the independent claims, while other features thereof are described in the dependent claims.

The object of the invention is a LED strip which does not break when bent, folded, or bowed, thereby providing correct illumination, even when bent, folded, or bowed. The technical problem to be solved is to configure the LED strip so as to obtain the mentioned object.

The present invention relates to a LED strip with discontinuous illumination comprising at least a first section, in turn comprising a laminar support on one or both faces of which LEDs are attached, as is known in the state of the art.

The invention is characterized in that the LED strip further comprises a second section after the first section, comprising at least one conductor connected to the first section, whereby the electrical connection, and therefore the illumination of the LEDs, are assured, such that said strip can be bent, bowed, or folded by the second section in the same plane as that of the laminar support.

The invention therefore relates to a LED strip having two clearly differentiated regions: one region, corresponding to the first section, which has LED diodes for illumination, and another region, corresponding to the second section, which does not have any illumination components, only the minimum components necessary to ensure electrical continuity, and allows transmitting power supply through bends, folds, bows and preventing splicing.

A simple configuration of a first section and a second section is mentioned in this specification; however, it can go on indefinitely in the desired manner and with the desired combination of sections.

Advantages of the claimed LED strip include:
reduction of costs per meter, since there is a part, i.e., the second folding section without LEDs, having a much lower cost than the other part, i.e., the first illumination section with LEDs, covering the same linear distance as a conventional LED strip;
reduction of installation costs for discontinuous illumination systems because the sections are not interconnected with cables, the strip itself being the element which transmits the power supply;
allowing turns, bends, and folds to be made in all directions, where these turns, bends, and folds must be made in the non-illumination regions, i.e., the regions without LEDs, the region corresponding to the first section.

### BRIEF DESCRIPTION OF THE FIGURES

The present specification is complemented with a set of figures that illustrate the preferred example and in no way limit the invention.

FIG. 1 depicts a partial plan view of a LED strip with two first sections on both sides of a second section arranged at the center.

FIG. 2 depicts the LED strip of FIG. 1 with a bend in a second section without LEDs and in the same plane of the laminar support of the LED strip.

FIG. 3 depicts a perspective view of a knot of a second section.

FIG. 4 depicts a diagram of a vertical arrangement of a LED strip with a knot in its upper part and a knot in its lower part.

### DETAILED DESCRIPTION OF THE INVENTION

FIG. 1 shows a LED strip with discontinuous illumination comprising at least a first section (1), two in the described embodiment, in turn comprising a laminar support (1.1) on one or both faces of which LEDs (1.2) are attached, as depicted, a second section (2), arranged in the figure in the center with respect to the first sections (1), comprising at least one conductor (2.1) connected to the first section (1), such that said strip can be bent, bowed, or folded by the second section (2) in the same plane as that of the laminar support (1.1), as shown in the figure in which a bend is made at a right angle.

This depiction is only a diagram showing two possibilities; however, bending, folding, bowing, including twisting, at any angle and plane is possible since only the conductor (2.1) will be affected.

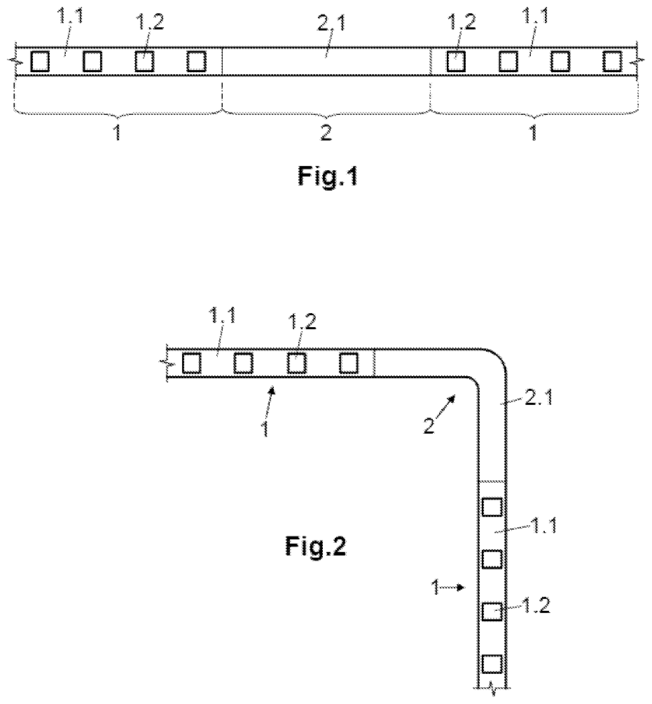

An advantageous option, as seen in FIGS. 1 and 2, consists of the conductor (2.1) of the second section (2) being configured as a continuation of the laminar support (1.1) of the first section (1). In other words, although the conductor (2.1) can be of any type, the same laminar support can be maintained in one and the same production process and sections with LEDs (1.2) and sections without LEDs (1.2) can be intercalated by way of a first section (1) and a second section (2), respectively.

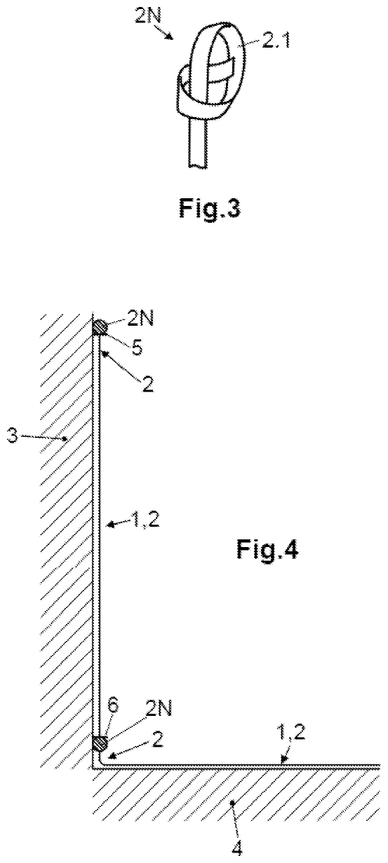

An option, as depicted in FIG. 3, consists of the conductor (2.1) of the second section (2) being able to be bent to form a knot (2N). This can be applied, for example, by way of a fastening element in and of itself since it produces a thickening which can act as a stop with respect to a support, such as a plate (5, 6), with a hole having a maximum width that is the width of the second section (2).

In that sense, for example, as depicted in FIG. 4, a second section (2) can be arranged at one end of the LED strip, said second section (2) being formed as a knot (2N) such that the LED strip can be arranged hanging from said knot (2N) supported, for example, on a first plate (5), by way of a vertical support. The LED strip then hangs along a wall (3) and there is made close to the lower end of the strip, where it forms a corner with the corresponding floor (4), another knot (2N), supported on a second plate (6) to thereby create tension in the section between plates (5, 6), and furthermore a second section (2) can then be bent to continue along the mentioned floor (4). This prevents having to include fastening elements for the LED strip every certain section which, in addition to increasing cost and complicating installation, is dangerous since an operator performing installation must lower himself or herself down the height of the wall (3) to place said fastening elements, whereas with the invention herein considered the operator will only have to arrange the strip from the knot (2N) and catch a plumb that falls therefrom in the proximity of the floor, without having to perform any actions along the wall (3) at all.

A non-depicted option consists of the LED strip having a partial or complete envelope by way of a capsule such as, for example, a capsule made of silicone or any other material, thereby taking advantage of the characteristics of the material which make it ideal for the invention herein considered, and therefore any bend, fold, bow is likewise applicable.

1. A LED strip with discontinuous illumination comprising at least a first section, in turn comprising a laminar support on one or both faces of which LEDs are attached, characterized in that the LED strip further comprises a second section comprising at least one conductor connected to the first section, such that said strip can be bent, bowed, or folded by the second section in the same plane as that of the laminar support.

2. The LED strip according to claim 1, wherein the conductor of the second section is configured as a continuation of the laminar support of the first section.

3. The LED strip according to claim 1, wherein the conductor of the second section is formed as a knot.

4. The LED strip according to claim 1, wherein a second section is arranged at one end of the LED strip, said second section is formed as a knot such that the LED strip can be arranged hanging from said knot.
